(19) United States
(12) Patent Application Publication
(10) Pub. No.: US 2025/0010584 A1
(43) Pub. Date: Jan. 9, 2025

(54) Automotive Window Laminate Structure, Thermoplastic Laminated Sheet Structure for Use Therein, and Method for Producing Said Automotive Window Laminate Structure via Heat Pressure Laminating Process

(71) Applicant: AUTOGLAS D & K B.V., Alphen aan den Rijn (NL)

(72) Inventor: Bartholomeus Leonardus Marinus Borcherd Driehuis, Alphen aan den Rijn (NL)

(21) Appl. No.: 18/709,994

(22) PCT Filed: Nov. 14, 2022
(86) PCT No.: PCT/NL2022/050651

§ 371 Date: May 14, 2024

(30) Foreign Application Priority Data
Nov. 15, 2021 (NL) 2029752

(51) Int. Cl. B32B 17/10; B32B 1/00

(52) U.S. Cl. CPC B32B 17/10871; B32B 1/00; B32B 17/10036; B32B 17/10302; B32B 17/1077; B32B 17/10788; B32B 2307/7376; B32B 2605/00

(57) ABSTRACT

An automotive window laminate structure, including a first glass sheet, and a second glass sheet. Said first and second glass sheet are parallel and mutually spaced apart, a thermoplastic laminated sheet structure, said laminated sheet structure substantially entirely placed between the first and second glass sheet. Said laminated sheet structure including, at least one functional layer, having an upper and lower surface, at least two bonding layers, wherein the at least two bonding layers substantially entirely cover the upper and lower surfaces of the at least one functional layer. A sealing, surrounding the perimeter of the thermoplastic laminated sheet structure, in particular the functional layer, configured for sealing the thermoplastic laminated sheet structure from a surrounding. A thermoplastic laminated sheet structure for use in said automotive window laminate structure, and to a method for producing the automotive window laminate structure via heat pressure laminating process.

### CROSS-REFERENCE TO RELATED APPLICATIONS

This application is the United States national phase of International Patent Application No. PCT/NL2022/050651 filed Nov. 14, 2022, and claims priority to The Netherlands Patent Application No. 2029752 filed Nov. 15, 2021, the disclosures of which are hereby incorporated by reference in their entireties.

### BACKGROUND OF THE INVENTION

### Field of the Invention

The present invention is related to an automotive window laminate structure, a thermoplastic laminated sheet structure for use in an automotive window laminate structure, and to a method for producing an automotive window laminate structure via heat pressure laminating process.

### Description of Related Art

Nowadays, functional layers comprise at least one active film layer like polymer-dispersed liquid-crystal (PDLC), Electro Chrome and other functional films like suspended-particle devices (SPD) are widely used in architectural glasses but are—more exceptionally—also used in the automotive industry. There are several reasons for that but in general, in the automotive industry, there is a higher demand in both safety regulations and quality issues. As an example, homologation in the automotive industry requires destructive tests, such as dropping steel balls from a height onto the window laminate structure, but also less destructive tests such as optical performance and boiling tests, to be passed.

Active or functional layers like SPD, PDLC or Electro-chrome all have in common that they are build up from two opposing thermoplastic layers, at their mutually facing sides provided with a conductive coating, mostly an ITO coated PET, PEN, PC or PMMA layer, in between which two layers the active film layer is provided. All have in common that if an electric current flows from the first conductive layer trough the liquid crystals to the second conductive layer, the crystals will be orientated aligned with the electric current causing a change in colour and/or light transmission and/or haze level. If such a layer is incorporated in a laminated glass structure it is called a functional layer, in particular an active functional layer. Incorporation is done by means of lamination process which commonly uses bonding layers and a frame layer. In this respect, the term active may be understood as a layer having an active functionality, such as being able to switch between different states, for example a state in which the layer is substantially transparent, and a state in which the layer is substantially opaque, or any state between transparent and opaque.

In general, the thermoplastic laminated sheet structure, comprising the functional and bonding layers, does not stretch all the way to the edges of the glass sheets of the automotive window laminate structure. In fact, an encapsulation of the perimeter of the thermoplastic laminated sheet structure is present to prevent the glass sheets from breaking. In particular the area where there is no functional layer allocated between the sheets of glass, and where the bonding layers extend beyond the functional layer, the openings/gaps in these areas needs to be compensated for in terms of thickness. The reason that the functional layer does not extend all the way to the edge of the sheets of glass is mainly to prevent the weather conditions, moisture, oxygen, salt (from coastal environment, or from de-icing of roads), window wiping liquid, and the like to get in contact with the functional layer or with the conductive coating of any layers thereof. Such a contact between the environment and the thermoplastic laminated structure may cause malfunctioning of the laminated structure, or even causes it to stop functioning at all. In particular moisture and plasticizers may affect the molecular structure of the active film in the functional layer. Commonly, said functional layer has a thickness which is comparable to the thickness of the bonding layers. A separate PVB frame layer is used to fill the gap between the two bonding layers where there is no functional layer. This prevents the glass from breaking, however, it does not properly seal the functional layer. As a result thereof, moisture or other unwanted elements may penetrate from the perimeter of the frame layer, which as discussed may affect the life span of the functional layer.

An ongoing trend in automotive is to reduce the weight of components. This trend is also present within the window structures. This is especially difficult taking into account the requirements set to these structures with respect to safety. Generally, the functional layers of the automotive window laminate structures a relatively thick. This, however, yields three disadvantages. Firstly, the thick functional layer requires the frame layer to prevent glass from breaking. Placing such a frame layer is a process which is hard to automize, and needs to be done very carefully and hence slowing down manufacturing. Secondly, these rather thick functional layers are quite heavy, which is disadvantageous for the automotive industry. Thirdly, the common functional layers have the disadvantage that they are hard to seal from the environment, which is caused by the fact that it has to be sealed within the frame layer, hence possibly preventing the frame layer from being applied correctly.

### SUMMARY OF THE INVENTION

It is therefore a first goal of the invention to provide an automotive window laminate structure which has a simpler composition.

It is a second goal of the invention to provide an automotive window laminate structure which has an improved seal of the functional layer.

The present invention thereto proposes an automotive window laminate structure, comprising a first glass sheet, and a second glass sheet, said first and second glass sheet are parallel and mutually spaced apart, a thermoplastic laminated sheet structure, said laminated sheet structure substantially entirely placed between the first and second glass sheet, said laminated sheet structure comprising, at least one functional layer, in particular an active functional layer, having an upper and lower surface, at least two bonding layers, wherein the at least two bonding layers substantially entirely cover the upper and lower surfaces of the at least one functional layer, a sealing, surrounding the perimeter of the thermoplastic laminated sheet structure, in particular the functional layer, configured for sealing the thermoplastic laminated sheet structure from a surrounding, wherein said thermoplastic laminated sheet structure stretches essentially entirely to the perimeter of the first and second glass sheet, and wherein said sealing is, along at least a portion of the perimeter of the thermoplastic laminated sheet structure, at least partially formed by at least one of the at least two bonding layers, preferably by both.

The present invention herewith allows for an easier construction of the automotive window laminate. Since the thermoplastic laminated sheet structure stretches essentially entirely to the perimeter of the first and second glass sheet, there is no need for providing a frame layer. That is, the present invention relates to a frameless automotive window laminate structure. Where according to the prior art a frame layer is to be present to ensure for a proper alignment and seal of the functional layer, the present invention allows to realize this result without said frame layer. In order to make this possible, the seal which surrounds the perimeter of the thermoplastic laminated sheet structure, in particular the functional layer, is at least partially formed by at least one, preferably both bonding layers. As such, the thermoplastic laminated sheet structure may as such be aligned with the perimeter of the glass sheet, and the bonding layer realizes said seal of the functional layer. Preferably the seal stretches along the entire perimeter of the thermoplastic laminated sheet structure, wherein essentially the entire seal is formed by the at least one, preferably two bonding layers. It is conceivable that the bonding layers may essentially gas tight enclose all sides of the functional layer, said bonding layers in particular directly adhered onto all sides of the functional layer such as to form a single uniform bonding layer enclosure.

If a portion of said seal is formed by one bonding layer there are some further preferences. For example, in this respect it is preferred that at least one bonding layer, at least partially, extends beyond the perimeter of the functional layer. As such, the bonding layer may seal the portion of the functional layer where it extends beyond. In particular this embodiment is advantageous if Thermoplastic Polyurethane (TPU) is used as said latter bonding layer. This allows for an easier formation of the seal, reducing the cost of the established window laminate.

It is conceivable and preferred that the at least one functional layer is an active layer. In particular wherein said active functional layer is able to switch between a partially transparent and a partially opaque state. Alternatively, it is conceivable that the active functional layer is configured for switching between different colours of. Preferably, said at least one active functional layer is switchable based on a current and/or voltages applied to an anode and cathode of the functional layer. It is moreover conceivable that the functional layer comprises segments or crossed segments forming pixels, wherein said segments and or pixels are mutually independently switchable.

Preferably, the automotive window laminate structure is a curved automotive window laminate structure. The present invention is more advantageous when the sheets of glass comprise at least a single curvature, optionally the window laminate structure may be a double curved window laminate structure. The present invention's advantages arise even further in this case. The greater the curvature, the harder it is to apply a frame layer around the thermoplastic laminate sheet structure. Also, applying a seal is more difficult if the window laminate structure is curved, this has to do with the fact that it is preferred that a single seal, which is commonly a piece of Kapton tape, is used. However, it is difficult to wrap a single piece of tape around the perimeter of a curved thermoplastic laminated sheet structure without introducing a wrinkle. However, using multiple pieces of tape introduces areas where the seal is prone to penetration of moisture into the thermoplastic laminated sheet structure. However, the present invention solves this problem, since the bonding layers realize the seal, which are less prone to wrinkling. Especially since the bonding layers may mutually realize a seal of the functional layer when they are brought in a condition which allows them to change shape, such as increased temperature and/or pressure.

Even though these thicker functional layers are subject to numerous disadvantages, it is cumbersome to substitute them with a thinner functional layer whilst meeting the same automotive requirements. Thin functional layers are prone to waviness or wrinkling under the pressure lamination process. In particular when the window has a curvature, or double curvature, waviness or wrinkles may easily be introduced into the laminate. These waves or wrinkles may prevent the functional layer from properly working. Especially, when a large automotive window laminate is to be provided with such a thinner functional layer, excessive wrinkles may be introduced by pressure heat lamination process, which causes the parallelism in the active film of the functional layer to be affected. The wrinkles are generally oriented in the largest direction of the functional layer. Besides the wrinkles, thinner functional layers are more difficult to seal from the surrounding using the features of the state of the art. It is therefore a further goal of the invention to reduce the weight of the functional layer. In a different embodiment of the present invention, the thickness of the functional layer is less than 0.30 mm, preferably less than 0.20 mm. More in particular the functional layer has a thickness of less than 0.15 mm. Using such a type of functional layer a significant decrease of weight may be realized. preferably, the functional layer of the Automotive window laminate structure has a surface of at least 1000 cm2, preferably at least 1500 cm2, more preferably at least 2000 cm2. In particular the functional layer has a surface of at least 1000 cm2, preferably at least 1500 cm2, more preferably at least 2000 cm2. In particular the combination of a large functional layer and/or thermoplastic sheet, with a thickness which is less than 0.30 mm, preferably less than 0.20 mm proves to be difficult to laminate. To this end, preferably at least the two bonding layers covering the upper and lower surface of the functional layer are composed out of Ethylene-Vinyl Acetate (EVA) or Thermoplastic Polyurethane (TPU). It is conceivable that bonding layers composed out of a different material are used, as long as their thermoplastic properties are similar to that of TPU and EVA which both has relative low softening points. To this end, when a relatively large, and thin functional layer is used, it was found that the desired result was not met when using polyvinyl butyral (PVB) as a material for the bonding layer. Using PVB as a bonding layer is not suitable for realizing a substantially gas tight seal of the functional layer. Also, since the softening temperature of PVB is higher compared to that of TPU and EVA, it has turned out currently less suitable for use in the automotive window laminate structure according to the invention. However, in case PVB bonding layers become available which have a lower softening temperature and preferably also cross linking, said future PVB may conceivably be compatible. In particular the wrinkling of the thin functional layer may not be sufficiently suppressed using PVB. Using TPU and/or EVA has proven to produce a reliable result, wherein the amount of wrinkling of the functional layer is minimum. Although PVB may not be used according to this invention as a first set of bonding layers, that is, the pair of bonding layers directly affixed to the functional layer, it is conceivable that a further pair of bonding layers is provided. This further pair of bonding layers, which may be affixed to outer surfaces of the initial pair of bonding may be composed out of any bonding layer material, including PVB. If PVB is used as a further bonding layer, that is, directly or indirectly affixed to the at least one primary bonding layer, the first bonding layer should be TPU. It was found that the combination of EVA with a further PVB layer is not mutually compatible. Surprisingly, it was found that, if at least one thermoplastic layer of the functional layer is thicker than the other, at least one bonding layer out of PVB may be used, instead of the bonding layers being both TPU or EVA. In particular, one PET layer may e.g., be 180 micron, or 150 micron, whereas the other PET layer is e.g., 100 micron, preferably 50 micron. The PVB layer may in this case be on the side of the thicker PET layer. Preferably, a TPU bonding layer is provided on the side of the functional layer facing away from the PVB bonding layer. The combination of a TPU and a PVB bonding layer is in particular advantageous, since PVB may provide for increased structural performance, whereas the TPU may allow for increased sealing, this is especially the case if the functional layer has a cascade shaped edge, to where the PVB sided PET layer extends beyond the edge of the TPU sided PET layer. Said cascaded configuration makes it is possible that a thin functional layer is used, whilst preventing wrinkles from forming due to the use of the TPU on the side of the thin thermoplastic PET layer. Nevertheless, the use of PVB, which is cheaper and may be more easily tinted, does not affect the wrinkles since it is provided on the thicker thermoplastic PET layer. The seal is thus realized by the TPU. Moreover, the thicker PET layer may function as a flat printed circuit, and function as a barrier against plasticisers of the PVB.

If both of the bonding layers are composed out of TPU, it is possible to achieve a proper seal of a functional layer comprising thermoplastic PET layers with a thickness of 50 micron. Hence, allowing to form a significantly thinner functional layer, whilst preventing wrinkles from forming between the sheets of glass, due to the TPU. This configuration additionally may render the use of an obscuration band, which is typically made out of black ceramic enamel, not necessary. Therefore, a more aesthetically pleasing finish of the automotive window may be achieved by using two TPU bonding layers. That is, no frame layer is required, since the seal may be formed by the TPU bonding layers.

Preferably, the surface area of the functional layer of the automotive window laminate structure is situated between 1000 cm2 and 16000 cm2. It was found that this particular size of windows is prone for wrinkles to form in the thermoplastic laminated sheet structure, in particular the functional layer thereof. This problem was especially observed when using a thin thermoplastic laminated sheet structure. In particular if the overall thickness of the thermoplastic laminated sheet structure without the bonding layers is within the range of to 0.1 mm to 0.40, preferably to 0.25 mm. Said wrinkles particularly form during lamination of the window and may be seen in the final product. This is undesired since it affects the appearance of the product. It has surprisingly been found that using a particular at least one bonding layer such as TPU and/or EVA allows to solve the cause of wrinkles being formed in the thermoplastic laminated sheet structure, which may enable to solve the cause of wrinkles in said dimensions of windows. In this respect, the TPU or EVA bonding layer should be attached directly to the functional layer in order to prevent wrinkles from forming. The TPU or EVA bonding layer is, in case at least one thick PET layer is used as mentioned above, provided on the side of the functional layer facing away from the thick PET layer. A functional layer having a thin PET layer is more prone to form wrinkles under the heat of the laminating process. In particular when using thinner PET layers, such as a thickness between 50 micron and 150 micron, in combination with the use of a PVB bonding layer adjacent to the thin PET layer. The thin PET layer and the adjacent PVB bonding layer may during the laminating process have mutually incompatible viscosity parameters, causing friction between said layers during the laminating process. Therefore, use of the TPU or EVA bonding layer in combination with the thin PET layer yielded surprising results, showing particular compatibility between thin PET layers of the functional layer and the adjacent TPU or EVA bonding layer, in particular the TPU bonding layer. Optionally, even better results are obtained by prebonding of the bonding layer and the functional layer. A particular example of a TPU bonding layer is NovoGenio Type SF1959 High Modulus or SF1964 Low Modulus. Said latter to particular examples have been physically crosslinked during the manufacturing of said bonding layers.

Preferably, the functional layer is less than 0.30 mm, preferably less than 0.20 mm. By using a relatively thin functional layer, it may be achieved to gas tight seal the functional layer using the bonding layers, without the presence of a frame layer. That is, the functional layer stretches almost entirely to the perimeter of the glass. This is possible since the functional layer is thin, which eliminates the need for filling the gap between the bonding layers since the bonding layers may overcome the limited thickness when softening. Preferably the functional layer is an SPD or Electrophorese layer with a thickness between 10-100 micron. More preferably, the functional layer is an Electro-Chrome, or PDLC layer with a thickness between 2-40 micron. The functional layer may for example comprise two thermoplastic layers, and one film layer, or active layer. Preferably, the at least one functional layer comprises at least two thermoplastic layers, and at least one film layer between the at least two thermoplastic layers, said film layer having a maximum thickness of 0.05 mm, and at least one of said thermoplastic layers, preferably each having a maximum thickness of 0.15 mm. The thermoplastic layers may each be provided with a conductive coating on their mutually facing surfaces, preferably an Indium Tin Oxide (ITO) coating. The thermoplastic layers may be composed out of polyethylene terephthalate (PET), and/or polyethylene naphthalate (PEN). The at least one film layer may be in particular a polymer-dispersed liquid-crystal device, and/or a suspended-particle devices, and/or an electrochromic device, and/or micro-blinds. Preferably at least one of the thermoplastic layers have a maximum thickness of 0.15 mm, preferably 0.1 mm, more preferably 0.05 mm.

Preferably, at least one, preferably the at least two bonding layers stretch, along at least a part of the perimeter of the at least one functional layer, at least 1 mm beyond said functional layer, preferably at least 3 mm. Preferably, a part of the perimeter of the at least one functional layer has an offset with respect to the perimeter of the glass sheets of at least 1 mm, preferably between 3 and 10 mm. This allows the bonding layers to fully enclose the functional layer, and as such forming the seal of the functional layer. Preferably, the seal stretches along the entire perimeter of the functional layer. Preferably, along the entire stretch of the seal, said seal is formed by the bonding layers. It is conceivable that along a part of the perimeter of the thermoplastic laminated sheet structure, the functional layer is not directly sealed by the bonding layers, this portion may be formed by a connector for powering the functional layer. Said connector may be attached to the anode and cathode of the functional layer, and may protrude the thermoplastic laminated sheet structure, such that at the part of the perimeter where the connector is connected to the functional layer, there may locally be no direct sealing of the functional layer by the bonding layers. It is however conceivable that the bonding layers may seal the part of the perimeter where the connected is present, and hence the bonding layers may seal the part where the connector is present, sealing the connector and/or functional layer.

It is conceivable that the layers of the thermoplastic laminated sheet structure are pre-bonded layers, wherein in particular the at least two bonding layers are pre-bonded to the functional layer, wherein said two bonding layers form an integral encapsulation which essentially entirely encapsulates the functional layer, such that the functional layer is gas-tight sealed. Pre-bonding the layers of the thermoplastic laminated sheet structure may allow for a more accurate process, since the seal of the functional layer may be inspected before laminating said pre-bonded laminated sheet structure between the first and second sheet of glass. This may especially be beneficial in case the connectors are provided to the thermoplastic laminated sheet structure. Said connectors may allow for contacting the anode and cathode of the thermoplastic laminated sheet structure, which may provide power to the sheet structure. It is conceivable that said connector at least partially protrudes from the laminated sheet structure, wherein the part where the connector protrudes from said sheet structure is also sealed by the bonding layers. That is, essentially no moisture, or other unwanted elements may penetrate the sheet structure, in particular functional layer via the connector. Preferably, the bonding layers of the pre-bonded thermoplastic laminated sheet structure are in a crosslinked state. This further contributes to the robustness of the thermoplastic laminated sheet structure. This may in particular contribute to the seal realized by the bonding layers, since the crosslinked state allows for the bonding layers to mutually form an integral bonding layer along a part of the perimeter of the functional layer where the bonding layers extend beyond said functional layer. Bonding layers may still be laminated after cross linking. Cross linking typically increases the softening point of the layer. Therefore, the conditions for successfully laminating may alter (i.e., temperature may need to be higher with respect to the pre-cross-linked state). Hard and soft (post) cross linking may alter the viscosity and possibly the final mechanical strength. However, after gaps between the thermoplastic laminated sheet structure and the glass sheets are filled, low viscosity is no longer required as a higher viscous (post cross linked) bonding layer still adheres to glass. Although, the adherence to glass of a post cross linked bonding layer may be slightly lower compared to a non-cross-linked variant, this slightly lower adherence contributes to impact resistances as delamination during impact arises. The amount of adhesion may be measured with the pummel test method, which is a well-known method in the field for testing laminated glass. To this end, at least one type of the bonding layers, comprises at least one cross linking agent.

Preferably the moisture content of at least one, preferably all bonding layers is situated below 0.3% by weight, in particular after lamination. The moisture is preferably extracted from the bonding layers before and/or during the laminating process. This level of moisture content is beneficial for creating a decent seal of the functional layer. The moisture in the bonding layers may cause problems, which mostly occur at higher temperatures, that is for example during the laminating process. The moisture inside the bonding layer may cause a reaction with the active film, such as the liquid crystals, which may result in unrepairable damage to the active film. The moisture content may be measured according to known methods. For example, a method for measuring the moisture content prior to laminating may be done by measuring the H—OH bands at 1930 cm⁻¹. This allows measuring the bonding layer prior to laminating. However, for measuring the water of moisture content in a laminated structure is done with a spectrophotometer. In particular in the wavelengths from 1650 nm up to 1925 nm. Here, the absorption rate (AR) is compared to reference samples. The latter method is widely accepted in the field of automotive laminated windows for measuring moisture and water content in a laminated glass structure, hence after laminating. It is important to measure the moisture content after lamination, since the laminating process may affect moisture content. That is, if drying of the bonding layer(s) is done up to ultra-dry conditions it is has turned out more than likely that the moisture level goes back up during the lamination process. By moisture extraction during the initial lamination process by lowering the pressure to a level that water boils, this problem is solved and improved as not only water but also the easy migrating plasticizers are extracted. Besides all this, the process is much faster as drying takes several days. This extraction step is especially beneficial if PDLC is used, as migrating elements may cause edge clearing, this is a phenomenon of malfunction of the liquid crystals, locally seen from the perimeter of the film inwards, resulting in the edge of the functional film turning being in a permanent clear state. This differs significantly from SPD, where influence of moisture is dependent on age of the entire film.

The present invention is further related to a thermoplastic laminated sheet structure for use in an automotive window laminate structure according to the present invention. The benefits as disclosed in relation to the automotive window are also applicable to the thermoplastic laminated sheet structure, and are herewith incorporated by reference with respect thereto.

The present invention is yet further related to a method for producing an automotive window laminate structure via heat pressure laminating process, comprising the steps of a) providing a first and a second glass sheet, b) providing a thermoplastic laminated sheet structure between the first and second glass sheets, wherein said laminated sheet structure comprises at least one functional layer and at least one, preferably two bonding layers, wherein said functional layer is situated between the at least two bonding layers, or at least adjacent to one bonding layer c) adhering the at least two bonding layers to the first and second glass sheet by applying an external pressure on, and increasing the temperature of, the window laminate formed during step a) and b), in particular of at least one, preferably each, bonding layer of the window laminate, above the glass transition temperature of said bonding layers for a predetermined amount of time, d) sealing the functional layer situated with the at least two bonding layers during the period of increased temperature of step c).

The method according to the present invention allows for a more controlled and easy production of the automotive window laminate. Since there is no frame layer around the thermoplastic laminated sheet structure, the thermoplastic laminated sheet structure may be easily aligned with the perimeter, or edges, of the sheets of glass. This allows to eliminate the steps of carefully positioning the thermoplastic laminated sheet structure at a predetermined location on the glass sheets, and subsequently placing a frame layer around it. As such, the thermoplastic laminated sheet structure is placed on the proper location more easily. Additionally, since no frame layer is present, it is easier to apply a better and easier seal of the functional layer. Not sealing the functional layer results in the degradation of the functional layer over time due to moisture penetrating the functional layer. The seal may essentially gas tightly seal the functional layer from the surrounding. By raising the temperature, the seal may be achieved by the two bonding layers, which may as such form a single bonding layer. It is to be noted that the thermoplastic laminated sheet structure and/or the entire automotive window laminate may be brought into a condition that is situated below the boiling point curve of water, measured on an opposite parameter illustration, which is typical for near vacuum situations. Thus, the moisture, in particular the water, will evaporate extremely fast as the boiling point of water at e.g., 29 degrees Celsius is at 40 mbar. That is, the temperature and pressure during step c) are situated such that this point is below the boiling point curve of water, and hence water will evaporate. This will contribute to form a proper seal.

In a different embodiment, the functional layer is essentially gas tight sealed with the bonding layers during step d). Sealing the functional layer essentially gas tight prevents moisture from penetrating into the functional layer. This is of great importance, especially since the functional layer may stretch up to 5 mm from the perimeter of the sheets of glass. Therefore, a proper sealing of said bonding layer, which in the window laminates according to the prior art is fulfilled by the frame layer, is of great importance since the functional layer stretches further towards the perimeter of the glass compared to prior art.

It is conceivable that the thermoplastic laminated sheet structure provided in step b) is a pre-bonded thermoplastic laminated sheet structure. Hence the method may further comprise the step of prebonding the thermoplastic laminated sheet structure provided in step b), such that the thermoplastic laminated sheet structure is a pre-bonded thermoplastic laminated sheet structure, preferably prior to step c).

This allows the manufacturing to be executed in sequences, that is, the thermoplastic laminated sheet structure may be manufactured in advance. This may be beneficial from a logistic point of view, but also from a quality point of view. Since the seal of the functional layer is highly important it may be beneficial to pre-laminate the thermoplastic laminated sheet structure, since this provides the possibility to inspect whether the seal is properly formed.

Preferably, prebonding the thermoplastic laminated sheet structure comprises the steps of: i) pressing the bonding layers to the functional layer between two opposed rollers, wherein during step i), air between the bonding layers and functional layers is removed, and wherein at least a part of the seal of step d) is realized simultaneously with or essentially directly after, step i). Preferably, during step i) the temperature is increased by increasing the temperature of the area surrounding the rollers, or by heating the rollers. By removing the air between the bonding layers and the functional layer, in particular the thermoplastic layer thereof, the transparency of the window laminate may be improved. Additionally, by prebonding the functional layer and the bonding layers, the bonding layers may be attached more secure to the functional layer, which may be crucial whilst laminating the window laminate. By prebonding the bonding layers to the functional layer, less slip between the bonding layers and the functional layer may occur during lamination thereof between the sheets of glass. This may further reduce the chances of wrinkles being introduced to the window laminate. In particular the wrinkling of the functional layer may be reduced, since by prebonding it between the bonding layers, a firmer pre assembly is formed.

It is also conceivable that prebonding the thermoplastic laminated sheet structure comprises the steps of i) providing two essentially flat, preferably rigid plates, in particular rigid plates with a higher thermal expansion than glass, preferably composed out of polymethyl methacrylate (PMMA) or stretched ethylene propylene diene monomer (EPDM) onto the upper and lower surface of the thermoplastic laminated sheet structure, ii) applying an external pressure on the stacked package provided during step i), and increasing the temperature of at least a part of the stacked package until a bonding between the bonding layers and the functional layer is realized. A further benefit of this method for prebonding the thermoplastic laminated sheet structure, is that this method may be performed under a vacuum. More in particular, the flat plates may extend beyond the perimeter of the thermoplastic laminated sheet structure. As such, the thermoplastic laminated sheet structure may be entirely enclosed by the flat plates, wherein the plates may be attached to one another by means of a frame, or adhesive. Preferably, the air between the two plates may be removed by sucking the air out, forming a vacuum. This further provides an additional pressure exerted onto the thermoplastic laminated sheet structure, wherein under application of heat, the prebonded thermoplastic laminate may be realized. Preferably, the temperature of said at least a part of the stacked package is increased during step ii) to a temperature situated between 60 and 140 degrees Celsius. Preferably two ridged stretched EPDM plates together forms a flexible clamp, which allows after the temperature rise above the glass transition point of step ii) to pre-form the entire stack by pressing it into a predefined three dimensional shape, preferably a double curved three dimensional shape, while after cooling down the plates may return in their essentially flat initial shape, and the so called memory of the thermoplastic laminated structure still is reset to the three dimensional shape and thus remains in this three dimensional shape.

Preferably prebonding the thermoplastic laminate sheet structure further comprises the steps of: iii) providing, prior to step ii) at least one layer of adhesive thermoplastic sheet material, preferably adhesive thermoplastic polyurethane, between the upper and lower surface of the thermoplastic laminated sheet structure and the two respective essentially flat, preferably rigid plates, iv) removing, after the bonding between the bonding layers and functional layer is realized during step ii), said adhesive thermoplastic layer applied during step iii) and said essentially flat, rigid plates. Since the bonding layers may be relatively soft when temperature is increased, it is preferred that the bonding layers do not stick to the plates. To this end, a layer of thermoplastic sheet material, such as an interleave separation layer or interleave sheet, may be adhered to the outer surfaces of the bonding layers. As such, under increased temperature, the thermoplastic sheet will not stick to the plate, and allow the thermoplastic laminated sheet structure to be removed after prebonding. It is further preferred that the interleave sheet is to be removed after prebonding, which may be realized by ensuring that the side of the interleave does not adhere to the bonding layer, for example by means of an anti-stick agent, or coating, or by selecting the material of the interleave such that it does not stick. It is in general conceivable that the rollers or plates used for prebonding have an anti-stick surface, which prevents these rollers or plates from sticking to the thermoplastic laminated sheet structure. It is conceivable that said interleave layer is composed out of Polytetrafluoroethylene (PTFE).

Preferably the method further comprises a moisture extraction step, preferably prior to step c), comprising the step of bringing the thermoplastic laminated sheet structure under a vacuum condition, preferably a deep vacuum condition of at least 95% vacuum or bringing the thermoplastic laminated structure in a condition, preferably the temperature and pressure, below the boiling point curve of water, allowing moisture to evaporate. By bringing the thermoplastic laminated sheet structure under a vacuum condition, it has been found that more moisture may be extracted from the thermoplastic laminated sheet structure. It is conceivable that the moisture extraction step may be prior to step c), however, may also be prior to prebonding the thermoplastic laminate. It is preferred that the moisture extraction step is executed under a condition wherein the combination of temperature and pressure are situated below the boiling point curve of water, as such, the water that evaporates may be extracted from the bonding layers and/or sheet structure. By further reducing the moisture content before the actual laminating or prebonding process, it may be prevented that the moisture inside the bonding layer damages the functional layer during lamination and/or prebonding, in particular when temperature is increased. That is mainly since the moisture that is present in the thermoplastic laminated sheet structure may affect the liquid crystal, i.e. the functional layer, when the temperature is increased due to chemical reactions occurring between the moisture and the functional layer.

Preferably said vacuum condition is maintained for a period of at least 10 minutes, preferably at least 30 minutes, more preferably at least 60 minutes. As such, it has appeared that a thermoplastic laminated sheet structure may be realized having a moisture content that is less than 0.3%. That is, reducing the moisture content to a value below 0.3%, preferably below 0.2%. In particular wherein said aforementioned moisture content is measurable after the lamination process. Having the moisture content at this level has proven to maintain a better quality of the functional layer during the laminating and/or prebonding process. The moisture content may be measured according to known methods. For example, a method for measuring the moisture content prior to laminating may be done by measuring the H—OH bands at 1930 cm⁻¹. This allows measuring the thermoplastic laminated sheet structure prior to laminating. However, for measuring the water of moisture content in a laminated structure is done with a spectrophotometer. In particular in the wavelengths from 1650 nm up to 1925 nm. Here, the absorption rate (AR) is compared to reference samples. The latter method is widely accepted in the field of automotive laminated windows for measuring moisture and water content in a laminated glass structure, hence after laminating. It is important to measure the moisture content after lamination, since the laminating process may affect moisture content. That is, if drying of the bonding layer(s) is done up to ultra-dry conditions it is has turned out more than likely that the moisture level goes back up during the lamination process. By moisture extraction during an initial lamination process by lowering the pressure to a level that water boils, this problem is solved and improved as not only water but also the easy migrating plasticizers are extracted. Besides all this, the process is much faster as drying takes several days.

Preferably, the method further comprises a preheating step prior to step b), wherein the thermoplastic laminated sheet structure, or at least the bonding layers thereof, is preheated to a temperature situated between 35 and 55 degrees Celsius, preferably between 40 and 50 degrees Celsius. By preheating the stack prior to step b) the difference in thermal expansion of the glass and the thermoplastic laminated sheet structure may be reduced. It may especially be beneficial when use is made of a prebonded thermoplastic laminated sheet structure. Preferably, preheating may be applied until the desired temperature of the thermoplastic laminated sheet structure is reached.

Preferably during step c), the temperature is increased at a minimum rate of 3 degrees Celsius per minute, preferably 5 degrees Celsius per minute, more preferably 10 degrees Celsius per minute. By allowing the temperature to increase fast, it has proven to reduce the wrinkling of the functional layer. This may be especially beneficial when use is made of a prebonded thermoplastic laminated sheet structure. By rapidly increasing the temperature, the outer portions, such as the bonding layers, of the thermoplastic laminated sheet structure may have already reached the temperature at which they start to get softer, allowing them to attach to the sheets of glass, whilst internally, the temperatures may still be lower, which keeps the internal parts firmer together, and prevents possibilities of mutually slipping sheets of the thermoplastic laminated sheet structure.

### BRIEF DESCRIPTION OF THE DRAWINGS

The terms Fig., Figs., Figure, and Figures are used interchangeably in the specification to refer to the corresponding figures in the drawings.

The present invention will hereinafter be further elucidated based on the following figures, wherein:

FIG. 1 shows a cross sectional view of an embodiment of the automotive window laminate; and

FIG. 2 shows a thermoplastic laminated sheet structure for use in an automotive window laminate.

### DESCRIPTION OF THE INVENTION

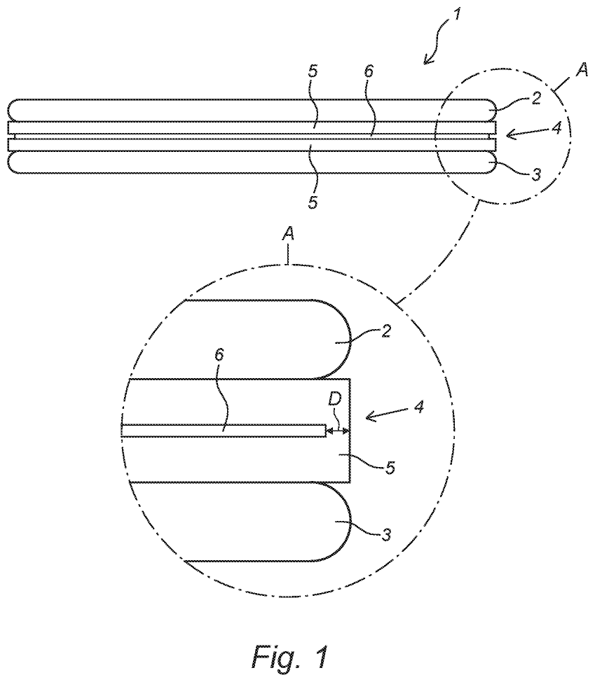

FIG. 1 shows a non-limitative embodiment of an automotive window laminate 1 according to the invention. The schematic representation of this simplified embodiment depicts a first and a second sheet of glass 2, 3. Said first and second sheet of glass 2, 3 are spaced apart and substantially parallel. Between said first and second sheet of glass 2, 3 a thermoplastic laminated sheet structure 4 is provided. The thermoplastic laminated sheet structure 4 comprises at least two bonding layers 5, wherein a functional layer 6 is provided between the two bonding layers 5. Preferably, the bonding layers 5 are bonding the functional layer to the sheets of glass 2, 3. However, in addition to bonding the functional layer 6 to the sheets of glass 2, 3, it is conceivable that the bonding layers 5 fulfil a further function. That is, preferably the bonding layers 5 at least partially seal the functional layer 6 from a surrounding, at least along a part of the perimeter of the functional layer 6. As such the bonding layers 5 may prevent moisture from penetrating into the functional layer 6 and hence may increase the lifespan of the functional layer 6. The encircled end portion A of the automotive window laminate 1 is depicted enlarged in more detail below. The enlarged portion A depicts that the bonding layers 5 are enclosing the functional layer 6, such as to form a seal. Preferably, the bonding layers 5 extend to the perimeter of the first and second sheet of glass 2, 3. The functional layer 6 preferably stretches to a distance D from the perimeter of the bonding layers 5. This may allow the bonding layers 5 to essentially entirely enclose the functional layer 6 such as to essentially gas tight seal the functional layer 6 from the surrounding. As shown in the figure, the automotive window laminate 1 is essentially free of a frame structure or frame layer, which is normally provided according to the prior art. That is, the functional layer 6 stretches to a distance D, which may be for example 5-10 mm, from the perimeter of the glass sheets 2, 3. This allows the automotive window laminate 1 to be able to have a larger functional surface, and hence decreasing the surface of black masking that is to be provided on a part of the window where the frame layer or frame structure is present normally.

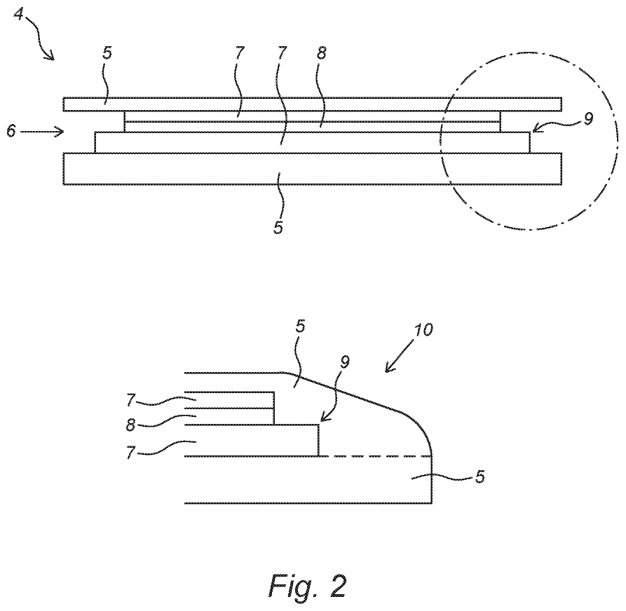

FIG. 2 shows a thermoplastic laminated sheet structure 4 according to an advantageous embodiment. The thermoplastic laminated sheet structure 4 comprises at least two bonding layers 5, wherein a functional layer 6 is provided between the two bonding layers 5. Preferably, the bonding layers 5 are bonding the functional layer to sheets of glass, which in this figure are not shown for illustrative purposes. However, in addition to bonding the functional layer 6 to the sheets of glass 2, 3, it is conceivable that at least one of the bonding layers 5 fulfil a further function. That is, preferably the bonding layers 5 at least partially seal the functional layer 6 from a surrounding, at least along a part of the perimeter of the functional layer 6. As such the bonding layers 5 may prevent moisture from penetrating into the functional layer 6 and hence may increase the lifespan of the functional layer 6. The particular embodiment of the thermoplastic laminated sheet structure 4 shown in this figure comprises a cascaded arrangement. In particular, the lower bonding layer 5 as depicted in the figure may be thicker, such as PVB. This may be the case if the functional layer 6 has an asymmetric composition. That is, one thermoplastic layer 7 of the functional layer 6 is thicker compared to the other. In particular the lower thermoplastic PET layer 7 in this figure has a thickness between 100 and 150 micron, whereas the upper thermoplastic PET layer 7 has a thickness of about 50 micron. On the side of the thicker thermoplastic PET layer 7, the thicker PVB bonding layer 5 may be arranged. This is possible since the thicker PET layer 7 may prevent penetration of plasticizers. On the side of the thin PET layer 7 of the functional layer, a bonding layer 5 which is composed out of TPU is provided. Said TPU bonding layer is more compatible with the thinner PET layer 7 of the functional layer 6, and is due to its lower softening temperature able to prevent wrinkles from forming in the functional layer 6, in particular during lamination. Said TPU bonding layer 5 moreover allows for forming a seal 10 around an edge 9 of the functional layer 6. This figure is a particular example, and should not be limitative to the inventive concept of the present invention.

1. A method for producing an automotive window laminate structure via heat pressure laminating process, comprising the steps of:
a) providing a first and a second glass sheet,
b) providing a thermoplastic laminated sheet structure between the first and second glass sheets, wherein said laminated sheet structure comprises at least one functional layer and at least two bonding layers, wherein said functional layer is situated between the at least two bonding layers,
c) adhering the at least two bonding layers to the first and second glass sheet by applying an external pressure on, and increasing the temperature of, the window laminate formed during step a) and b) above the glass transition temperature of said bonding layers for a predetermined amount of time,
d) sealing the functional layer situated with the at least two bonding layers during the period of increased temperature of step c).

2. The method according to claim 1, wherein during step d) the functional layer is essentially gas tight sealed with the bonding layers.

3. The method according to claim 1, wherein the method further comprises the step of prebonding the thermoplastic laminated sheet structure provided in step b), such that the thermoplastic laminated sheet structure is a pre-bonded thermoplastic laminated sheet structure, preferably prior to step c).

4. The method according to claim 3, wherein prebonding the thermoplastic laminated sheet structure comprises the steps of:
i) pressing the bonding layers to the functional layer between two opposed rollers;
wherein during step i), air between the bonding layers and functional layers is removed, and wherein at least a part of the seal of step d) is realized simultaneously with or essentially directly after, step i).

5. The method according to claim 3, wherein prebonding the thermoplastic laminated sheet structure comprises the steps of:
i) providing two essentially flat, rigid plates onto the upper and lower surface of the thermoplastic laminated sheet structure,
ii) applying an external pressure on the stacked package provided during step i), and increasing the temperature of at least a part of the stacked package until a bonding between the bonding layers and the functional layer is realized.

6. The method according to claim 5, wherein the temperature of said at least a part of the stacked package is increased during step ii) to a temperature situated between 60 and 140 degrees Celsius.

7. The method according to claim 5, wherein prebonding further comprises the steps of:
iii) providing, prior to step ii) at least one layer of adhesive thermoplastic sheet material between the upper and lower surface of the thermoplastic laminated sheet structure and the two respective essentially flat, rigid plates,
iv) removing, after the bonding between the bonding layers and functional layer is realized during step ii), said adhesive thermoplastic layer applied during step iii) and said essentially flat, rigid plates.

8. The method according to claim 1, wherein the method further comprises a moisture extraction step, comprising the step of bringing the thermoplastic laminated sheet structure under a vacuum condition, below the boiling point curve of water allowing moisture to evaporate, wherein said vacuum condition is maintained for a period of at least 10 minutes.

9. (canceled)

10. The method according to claim 1, wherein the method further comprises a preheating step prior to step b), wherein the thermoplastic laminated sheet structure, or at least the bonding layers thereof, is preheated to a temperature situated between 35 and 55 degrees Celsius.

11. The method according to claim 1, wherein during step c), the temperature is increased at a minimum rate of 3 degrees Celsius per minute and/or wherein the prebonded thermoplastic laminated sheet structure is provided with a double curvature.

12. (canceled)

13. An automotive window laminate gel structure obtainable by the process according to claim 1.

14. An automotive motive window laminate structure, comprising:
a first glass sheet, and a second glass sheet, said first and second glass sheet are parallel and mutually spaced apart,
a thermoplastic laminated sheet structure, said laminated sheet structure substantially entirely placed between the first and second glass sheet, said laminated sheet structure comprising;
at least one functional layer, having an upper and lower surface,
at least two bonding layers, wherein the at least two bonding layers substantially entirely cover the upper and lower surfaces of the at least one functional layer,
a sealing, surrounding the perimeter of the thermoplastic laminated sheet structure, configured for sealing the thermoplastic laminated sheet structure from a surrounding,
wherein said thermoplastic laminated sheet structure stretches essentially entirely to the perimeter of the first and second glass sheet, and wherein said sealing is, along at least a portion of the perimeter of the thermoplastic laminated sheet structure, at least partially formed by the at least two bonding layers.

15. The automotive window laminate structure according to claim 14, wherein the automotive window laminate structure is a curved laminate structure and/or, wherein the functional layer of the Automotive window laminate structure has a surface of at least 1000 cm2.

16. (canceled)

17. The automotive window laminate structure according to claim 1, wherein a thickness of the functional layer is less than 0.30 mm and/or wherein the at least one functional layer comprises at least two thermoplastic layers, and at least one film layer between the at least two thermoplastic layers, said film layer having a maximum thickness of 0.05 mm, and at least one of said thermoplastic layers, having a maximum thickness of 0.15 mm.

18. (canceled)

19. The automotive window laminate structure according to claim 14, wherein at least the two bonding layers covering the upper and lower surface of the functional layer are composed out of Ethylene-Vinyl Acetate (EVA) or Thermoplastic Polyurethane (TPU).

20. The automotive window laminate structure according to claim 14, wherein the layers of the thermoplastic laminated sheet structure are pre-bonded layers, wherein the at least two bonding layers are pre-bonded to the functional layer, wherein said two bonding layers form an integral encapsulation which essentially entirely encapsulates the functional layer, such that the functional layer is gas-tight sealed.

21. The automotive window laminate structure according to claim 20, wherein the bonding layers of the pre-bonded thermoplastic laminated sheet structure comprises at least one cross linking agent, such that bonding layers of said thermoplastic laminated sheet structure are in a crosslinked state.

22. The automotive window laminate structure according to claim 20, wherein at least one stretches, along at least a part of the perimeter of the at least one functional layer, at least 1 mm beyond said functional layer.

23. The automotive window laminate structure according to claim 14, wherein the moisture content of at least one bonding layer is situated below 0.3% by weight.

24. (canceled)
